(19) United States
(12) Patent Application Publication
(10) Pub. No.: US 2012/0040718 A1
(43) Pub. Date: Feb. 16, 2012

(54) Pocket DJ

(76) Inventors: Adam Christian Ramirez, Fullerton, CA (US); Richard Anthony Ayala, Shittier, CA (US)

(21) Appl. No.: 13/211,029

(22) Filed: Aug. 16, 2011

Related U.S. Application Data
(60) Provisional application No. 61/374,157, filed on Aug. 16, 2010.

(51) Int. Cl. H04W 88/00

(52) U.S. Cl. 455/556.1

(57) ABSTRACT

The Pocket DJ is a mobile device combining the functionality of a cell phone and a DJ mixer. The invention has a top piece and bottom piece which house all of the vital components. The two pieces are attached along one edge, allowing them to flip open and closed, providing a robust yet compact design for users to take full advantage of both the cell phone and DJ mixer. A series of touch screen display panels are used to provide vital information to the user. While a set of turntables and various audio controls are used to create music mixes.

The current application is a nonprovisional application and claims a priority to the U.S. provisional patent application Ser. No. 61/374,157 filed on Aug. 16, 2010.

### FIELD OF THE INVENTION

The present invention relates generally to a portable DJ mixer which can be incorporated into mobile phones. The invention is able to seamlessly switch back and forth between the interfaces of the DJ mixer and mobile phone.

### BACKGROUND OF THE INVENTION

In recent years smart phone technology has enabled the creation of numerous interactive music and audio applications which can be downloaded and installed on mobile phones. However, these applications lack depth and do not provide enough features to serve a growing community of individuals interested in creating new music mixes. Some of the most notable exclusions from these applications are functioning turntables and other audio features which are fundamental tools for all DJs. This invention takes a different approach to solve this problem by providing separate DJ hardware and software which can be integrated into mobile phones, rather than downloaded. This allows users to carry a hand held device that functions as both a cell phone and a DJ mixer.

### BRIEF DESCRIPTION OF THE DRAWINGS

FIG. 1 is a perspective view of the present invention when fully closed

FIG. 2 is a perspective view of the present invention when partially opened, showing the DJ mixer and cell phone components

FIG. 3 is a top view of the present invention fully open, showing the DJ mixer

FIG. 4 is a perspective view of the present invention partially opened, showing the DJ mixer components

### DETAIL DESCRIPTIONS OF THE INVENTION

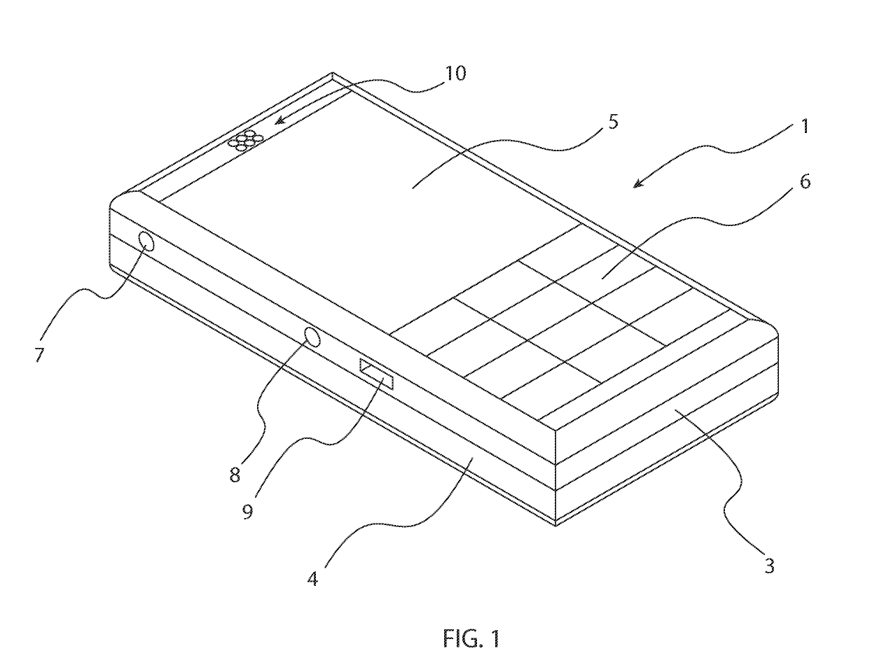

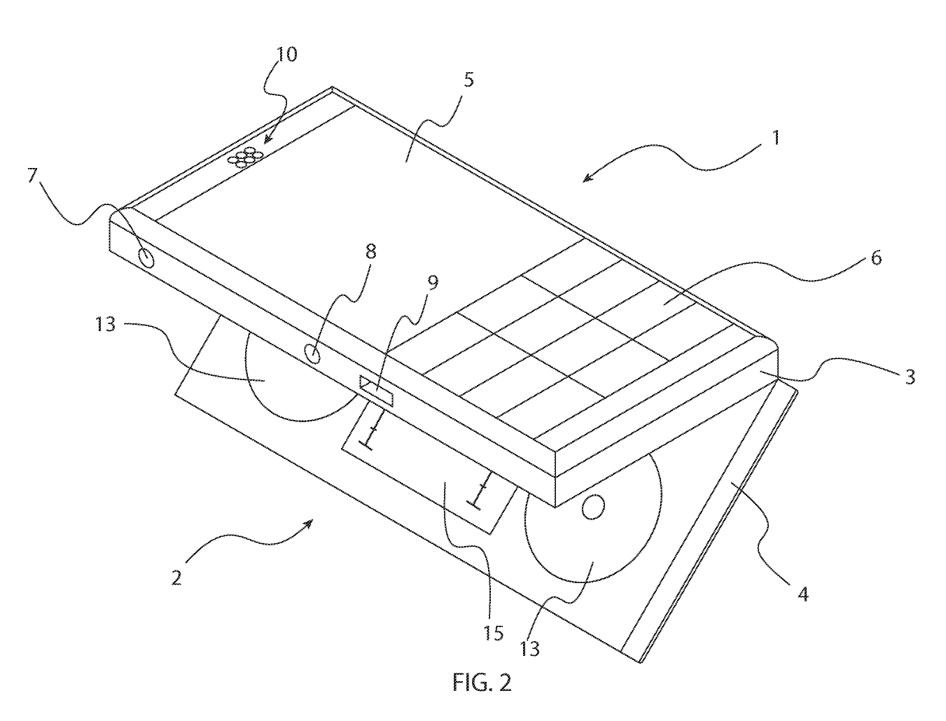

In reference to FIG. 1 and FIG. 2, the present invention combines the functionality of a mobile phone and portable equipment DJ into a single hand held device, comprising of a cell phone 1 and a DJ mixer 2. In the present design, the overall structure of the invention takes the form of a flip style phone. The structure comprises of a top piece 3 and bottom piece 4. The cell phone 1 is positioned on the top piece 3, and the DJ mixer 2 has its main components on both the top 3 and bottom 4 pieces. The top 3 and bottom 4 pieces are connected on one edge in a hinge like manner, allowing them to flip open and closed. When the invention is closed, the DJ mixer 2 is completely hidden on the inside. To activate the DJ mixer 2, the user flips the invention to swing out the DJ mixer 2, the DJ mixer 2 is located near where the keypad of a conventional flip phone would be found. The flip style design ensures that the user can operate the cell phone 1 without the DJ mixer 2 interfering with the functionality of the phone 1, and vice versa. The flip style also provides a more compact design and makes it easier to carry around.

The cell phone 1 is fully functional and has many of the basic features offered by conventional mobile phones. The cell phone display 5 is located on top of the top piece 3, it has touch screen functionality and is one of the main interfaces through which the user is able to interact with the phone 1. To compensate for the lack of a flip out keypad, the keypad 6 is now also located on top of the top piece 3. Near the top surface are a series of ports which enable the user to plug auxiliary devices into the invention. The headphone/Bluetooth input 7 accommodates both analog headphones as well as wireless Bluetooth devices. There is also a charger socket 8 as well as a USB port 9 allowing users to connect the invention to the computer. Finally, there are external speakers 10 mounted on the top surface of the top piece 3. Depending on the current setting; the external speakers 10 can be used as an ear piece when talking on the phone, a speaker phone, or speakers for music.

Alternatives to the flip style phone include a sliding phone, or any other configuration which allows the user to switch between the DJ mixer 2 and cell phone 1 seamlessly. In future configurations the DJ mixer 2 could function as its own autonomous unit without a mobile phone or be incorporated into other hand held devices.

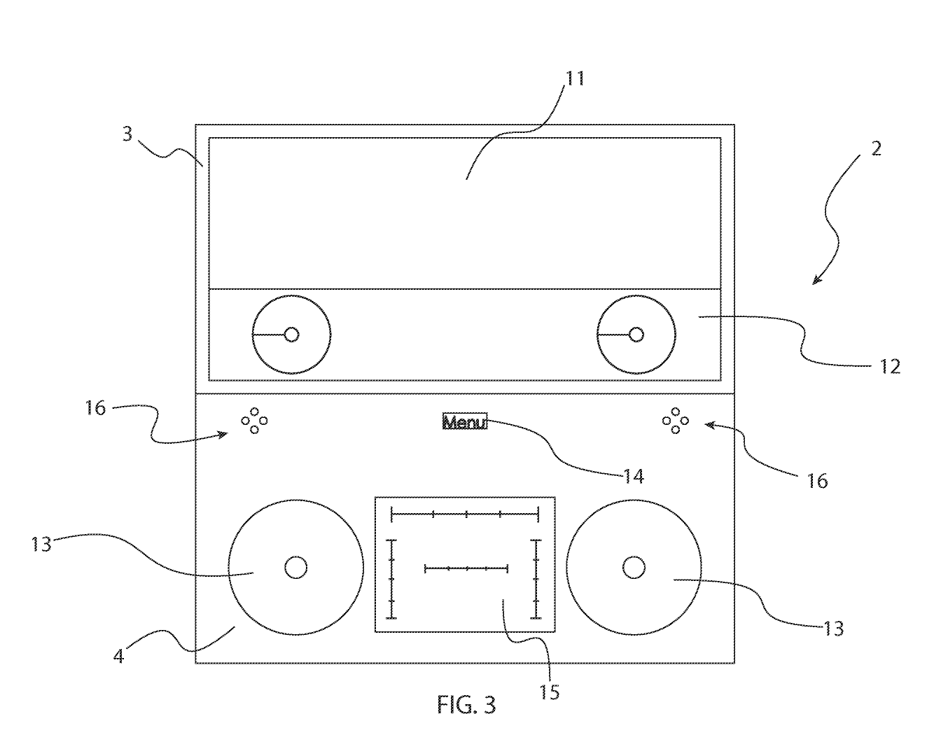

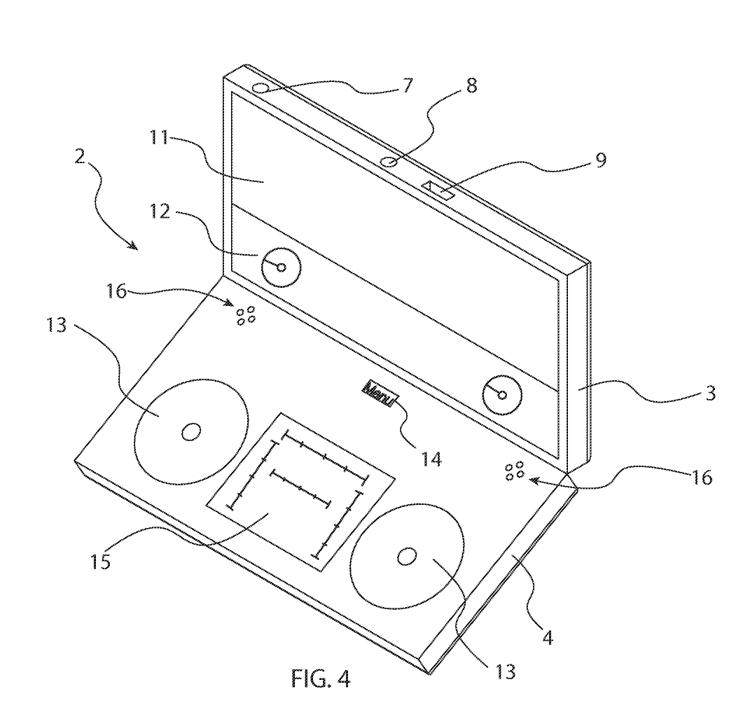

In reference to FIG. 1, FIG. 2, FIG. 3, and FIG. 4, the DJ mixer 2 is accessed by flipping open the invention. To flip open the invention, the user pulls apart the top piece 3 and bottom piece 4. As the pieces are pulled apart, the hinged connection allows the invention to open up and reveal the interior. With the hinged connection, the top 3 and bottom 4 pieces can rotate about their adjoining edge from a 0° angle when fully closed to a 180° when fully open. The DJ mixer 2, in similar fashion to portable audio playback device, allows users to store tracks as audio media files to listen to on the go, as well as record and create new mixes whenever and wherever they want. Audio media files are stored on an internal storage device which can be upgraded to provide a larger capacity to store and create music. Users are also able to share and upload all of the mixes that they create on the internet, to network with friends and other music enthusiasts. As previously mentioned, the invention can be hooked up to the computer, this allows the user to exchange files between the invention and the computer. Users are then able to use more in depth editing and manipulation software on the computer for their mixes. The DJ mixer 2 acts as the first platform for users to develop and create new mixes, and the computer provides more comprehensive software to refine their creations. The invention can also be connected to other devices, such as car stereos and other audio playback devices through the use of the various ports. Providing the user more ways to enjoy and share their music with others.

The internet connection also enables users to download applications which facilitate the recording and creation of new mixes. Examples include drum kits which can provide innovative sounds to a new mix. The various applications make the device more hands on and interactive for the user.

Referring to FIG. 3 and FIG. 4, the DJ mixer 2 has three main touch screen displays, a DJ panel 11, a track panel 12, and a turntable control panel 15. The DJ panel 11 and track panel 12 are located underneath the top piece 3, and the turntable control panel 15 is located on top of the bottom piece 4. The DJ panel 11 and track panel 12 are positioned next to each other, so that they appear as one continuous screen. The touch screen functionality allows the user to interact with these displays. The invention also has internal speakers 16 which are mounted on top of the bottom piece 4. Users are also able to plug in a microphone to the headphone/Bluetooth input 7, which allows users to incorporate external sounds and audio signals into new mixes, providing an in depth audio experience. The final interactive components of the DJ mixer 2 are the plurality of turntables 13. In the current design, there are two turntables 13, with one on each side of the top surface of the bottom piece 4. The turntables 13 are disc shaped and are fully rotatable. The turntables 13 are positioned such that the user can operate each turntable 13 with one hand while holding the invention. Users can spin the turntables 13 by placing their fingers on them and rotating them. By spinning the turntables 13, users are able to create their mixes by modifying the recording of currently playing audio media files. The turntables 13 are the primary components involved in mixing and modifying tracks.

The turntable control panel 15 is located in between the turntables 13. This display adds more features to modify the functioning of the turntables 13 as well as add additional audio control features. The audio control features include an assortment of cross faders and pitch controls. The turntable cross fader allows the user to fade in the tracks on one turntable while simultaneously fading out the other. The cross fader is controlled by a single bar with an indicator which users can slide with their fingers. By moving the indicator towards one of the turntables 13, the corresponding turntable fades in while the other fades out. Accompanying the turntable cross fader on the turntable control panel 15 are pitch controllers. Each of the turntables 13 are assigned a unique pitch controller, with the pitch controller displayed right next to the corresponding turntable. The pitch controller also uses a bar mechanism with a sliding indicator. The pitch controller regulates the speed at which the turntables 13 are operating, by sliding the slider up the user increases the speed, if slid down the speed decreases. The pitch controllers also display the speed in which the turntables 13 are operating in revolutions per minute (rpm). This feature aids the user when mixing multiple tracks at once to provide more comprehensive beat matching. The last feature displayed on the turntable control panel 15 is a headphone cross fader. This feature is only active when headphones are plugged into the invention. This cross fader serves a similar purpose to the turn table cross fader however, it gives autonomous control to the headphones, allowing users to have different settings for different devices.

The DJ panel 11 is the component which displays much of the information the user needs while using the DJ mixer 2, including song and artist information stored on the invention as audio media files. The touch screen functionality of the DJ panel 11 allows the user to navigate through it. Users are able to view lists of tracks, and are able to navigate through the lists by dragging their finger up and down the screen to scroll through. Users can also select songs by pressing on their title, users are then prompted to select which of the turntables 13 to play the audio media file on. Once the turntables 13 have been selected the track immediately begins playing. In this fashion, users are able to select songs to play simultaneously on the plurality of turntables 13, as well as select multiple songs to create a queue. In the current design, users are able to play two tracks simultaneously, one for each of the turntables 13.

Underneath the DJ panel 11 is the track panel 12. The track panel 12 shows the technical details of the playing tracks by showing the length of the song and the time remaining. The track panel 12 splits its screen to show the tracks on each of the individual turntables 13 separately. In the current design with two turntables 13, the track panel 12 is split in half displaying each song on the same side as the corresponding turntables 13. This allows users to closely monitor each song playing on the turntables 13. The track panel 12 also gives users control over the song by allowing users to start and pause the song, as well as indicate when to begin recording.

The menu button 14 is located on the top surface of the bottom piece 4. The menu button 14 serves as the main navigational tool for the user when using the DJ mixer 2. Pressing the menu button 14 displays the main menu on the DJ panel 11, providing numerous options for the user to choose and customize their experience. If the main menu is already displayed when the user presses the menu button 14 then the menu closes. From the main menu, the user can navigate to the music library to view all songs, a playlist view, volume controls, microphone controls, auto fader mode, track panel display modifiers, equalizer controls, and ignore calls mode.

The music library mode is the most basic display option, allowing users to view all of the stored audio media files in a simple list format on the DJ panel 11. Users can adjust the order of the tracks by sorting in alphabetic order, album title, or artist name. From this list users can select individual tracks to listen to, or for mixing purposes. The playlist mode displays all of the user's personal playlists on the DJ panel 11. It also provides the user the option to create more playlists or edit existing ones, if this route is chosen users can then select individual tracks to add to a new or existing playlist.

The volume controls allow users to control the internal 16 and external 10 speakers, as well as any Bluetooth device or headphone plugged into the invention. The microphone controls are enabled when a microphone has been plugged into the device. With this feature users are able to control its sensitivity to external sounds and change the volume levels with which it records.

The auto fader option enables for smooth transitions between songs. With this feature enabled, tracks play in succession and when the first track is about to end it slowly fades out as the upcoming track gradually fades in. This feature eliminates dead air in between tracks and removes the possibility of awkward transitions when switching tracks. This option can be used when going through a selected playlists or even the entire music library. The auto fader mode can only be enabled when listening to audio media files and not during mixing.

The equalizer feature provides a more advanced volume control feature for the user. While the volume control provides basic features to adjust the volume levels, the equalizer allows users to adjust the frequency response of the audio device. This enables users to make adjustments to the bass or treble of the audio signal. This feature provides more adjustability to the user and can be used to adjust either the external and internal speakers or auxiliary devices such as headphones.

The track panel display modifier allows users to choose one of four separate modes to display information on the playing tracks in the track panel 12. Each of the four modes has a unique approach to displaying information for the current tracks. Mode 1 shows the time in a record style display. This mode begins by having a blank disc with a line coming out from the center to its edge at the 9:00 position. This line gradually moves clockwise as the song plays. As it moves around the disk, it gradually fills to visualize the duration of the song. Once the line reaches the 9:00 position the song is over and switches to the next in queue. Depending on the length of the song, it will take varying amounts of time for the line to do an entire revolution around the disc. Mode 2 is a simple progress bar that gradually fills as the song plays. When the song is over, the bar is full. Mode 3 is a peak meter display which tracks the audio output of the current song. The peak meter provides a visual indication of the instantaneous level of the audio output through the use of time varying bars. Next to these visual display modes for the songs are the song titles as well as a timer showing the numerical song length and time remaining. The final mode allows the user to turn off all of these options. As a result, in the “off” mode the track panel 12 acts as an extension of the DJ panel 11 and displays a continuation of the output from the DJ panel 11.

Referring to FIG. 2 and FIG. 3, the final option on the main menu is the ignore calls feature. Selecting this option redirects all incoming calls directly to voice mail. This ensures that the user can operate the DJ mixer without being interrupted. Users can then check their voicemail to see who called and what messages were left. This feature also prevents pop ups on the screen when a text message arrives. This option is only active when the DJ mixer 2 is being used, and automatically disables when switching back to the cell phone 1. When this feature is not selected, users are alerted of incoming calls on the screen. If they choose to answer them, all activity on the DJ mixer 2 is paused. When the user hangs up the cell phone 1, the user is able to pick up right where they left on the DJ mixer 2.

The listed components and their capabilities create the functional Portable DJ. While the invention has been described in its preferred embodiment, it is to be understood that a variety of possible modifications can be made to fulfill the purposes of the invention. It is intended that the present invention cover all other embodiments that are within the scope of the appended claims and their equivalents.

What is claimed is:

1. A Pocket DJ comprises,
a cell phone;
a DJ mixer;
a top piece;
a bottom piece;
the cell phone being located on the top piece;
the DJ mixer being located on the top piece and the bottom piece;
the top piece and the bottom piece being hinged together;
the top piece and the bottom piece being able to be pulled apart or closed together; and
the top piece and the bottom piece being able to partially rotate about each other.

2. The Pocket DJ as claimed in claim 1 comprises,
the cell phone comprises of a cell phone display, a keypad, an external speaker, a charger socket, a USB port, and a headphone/Bluetooth input;
the cell phone display, the keypad, and the external speakers being positioned on top of the top piece;
the keypad being located below the cell phone display; and
the charger socket, USB port, and headphone/Bluetooth input being spread out around the top piece.

3. The Pocket DJ as claimed in claim 1 comprises,
the DJ mixer comprises of a DJ panel, a track panel, a plurality of turntables, a plurality of internal speakers, a menu button, and a turntable control panel;
the DJ panel and track panel being located underneath the top piece; and
the DJ panel and track panel appearing as one continuous screen.

4. The Pocket DJ as claimed in claim 3 comprises,
the plurality of turntables, the plurality of internal speakers, the menu button, and the turntable control panel being located on top of the bottom piece;
the turntable control panel being located in between the plurality of turntables; and
the menu button controlling information displayed on the DJ panel.

5. The Pocket DJ as claimed in claim 4 comprises,
the turntables being disc shaped; and
the turntables being fully rotatable.

6. A method of incorporating into a single device the functionalities of a mobile phone and an audio playback device with an interface capable of recording and manipulating audio signals, the method comprises the steps of:
sending and receiving information through GSM networks;
recognizing short range wireless communications;
storing audio signals internally in a digital format as audio media files;
playing audio media files by converting them into audio signals;
recording audio signals and converting them to a digital format as audio media files;
displaying objects which users can physically interact with through a touch screen;
converting certain physical interactions with the invention into digital manipulations of the audio signal;
transmitting and uploading audio media files digitally to external devices;
adjusting amplitude levels of audio signals; and
displaying a main menu as a navigational tool which can be interacted with physically to determine corresponding actions.

7. The method of incorporating into a single device the functionalities of a mobile phone and an audio playback device with an interface capable of recording and manipulating audio signals, the method as claimed in claim 6 comprises,
formatting and displaying internally stored audio media files in a list;
storing accompanying information with the audio media files such as artist name and album title;
organizing and comprehensively sorting lists of audio media files by determining factors such as alphabetical order and song duration; and
allowing the user to manually create and organize lists of audio media files with predefined orders.

8. The method of incorporating into a single device the functionalities of a mobile phone and an audio playback device with an interface capable of recording and manipulating audio signals, the method as claimed in claim 6 comprises,
converting digitally stored audio media files into audio signals;
using audio playback to project audio media files as audio signals;
controlling each currently playing audio media file separately and independently; and
controlling each audio media file by starting, stopping, or pausing the file.

9. The method of incorporating into a single device the functionalities of a mobile phone and an audio playback device with an interface capable of recording and manipulating audio signals, the method as claimed in claim 8 comprises,
adjusting the amplitude level of the audio output by simultaneously lowering the amplitude level of the currently playing audio media file and increasing the amplitude level of the upcoming audio media file;
adjusting the amplitude level of two simultaneously playing audio media files by increasing one and decreasing the other and vice versa;
displaying the speed of an audio media file that is playing on a turntable in revolutions per minute (rpm); and
adjusting the operating speed of the rotating turntables through pitch control.

10. The method of incorporating into a single device the functionalities of a mobile phone and an audio playback device with an interface capable of recording and manipulating audio signals, the method as claimed in claim 6 comprises,
recognizing externally produced audio signals
recording and converting externally produced audio signals into digital audio media files
mixing and manipulating multiple audio signals together to create new audio media files

11. The method of incorporating into a single device the functionalities of a mobile phone and an audio playback device with an interface capable of recording and manipulating audio signals, the method as claimed in claim 6 comprises,
determining the duration of a stored audio media file;
displaying quantitatively the total duration and time remaining for a currently playing audio media file;
displaying the time elapsed of a currently playing audio media file with a progress bar;
displaying the time elapsed of a currently playing audio media file with a circle that is gradually filled;
displaying amplitude levels of a currently playing audio signal in a peak meter graph; and
turning on and off the variety time displays.

12. The method of incorporating into a single device the functionalities of a mobile phone and an audio playback device with an interface capable of recording and manipulating audio signals, the method as claimed in claim 6 comprises,
storing audio signals in a digital format which are compatible with audio editing software on the computer;
transmitting data and digital audio files back and forth between a computer;
transmitting and uploading audio media files digitally to online storage devices; and
downloading digital media files from the internet to an internal storage device.
